(19) United States
(12) Patent Application Publication
(10) Pub. No.: US 2003/0117745 A1
(43) Pub. Date: Jun. 26, 2003

(54) Disc drive with a foldable support

(76) Inventor: Tsung-Jung Kuo, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/241,060

(22) Filed: Sep. 10, 2002

(30) Foreign Application Priority Data
Dec. 21, 2001 (TW) 90222570

(51) Int. Cl. G11B 17/00

(52) U.S. Cl. 360/97.01

(57) ABSTRACT

A disc drive with a foldable support. The disc drive comprises a main body and a foldable support mounted thereon. The foldable support includes a first strut and a second strut. One end of the first strut and the second strut are pivoted on the main body. The other end of the first strut slides on and along the second strut so that the disc drive can be deployed diagonally to save space.

### BACKGROUND OF THE INVENTION

1. Field of the Invention

The present invention relates to a disc drive with a foldable support, more particularly, to a disc drive that can be deployed diagonally to save space.

2. Description of the Related Art

Disc drives read or write data. As technique improves, disc drives with 10,000 RPM spindle motor speeds have become more popular.

Traditional external disc drives are normally placed horizontally. In some situations, there is not enough space to place an external disc drive horizontally on a plane, but enough to place it vertically or diagonally. It is usually not stable to place external disc drives vertically, and external disc drives need additional well-designed mechanisms to fix discs when deployed vertically. However, discs vibrate seriously when rotating vertically, creating a functional challenge. Thus, there is a need for a device to support an external disc drive deployed diagonally, wherein the drive is more stable and the vibration of discs when rotating is minimized.

### SUMMARY OF THE INVENTION

An object of the present invention is to provide a disc drive which can be deployed diagonally in limited space.

The present invention provides a disc drive with a foldable support, by which the disc drive can be deployed horizontally or diagonally, and the opening of the disc drive can selectively face forward, upward, or sideward. Thus, it is convenient for users to change the position and direction of the disc drive when using the disc drive with a foldable support.

The present invention provides a disc drive with a foldable support. The disc drive comprises a main body and a foldable support mounted thereon. The foldable support includes a first strut and a second strut. One end of the first strut and the second strut are pivoted on the main body. The other end of the first strut slides on and along the second strut so that the disc drive can be deployed diagonally.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a exploded perspective view of the disc drive of the present invention;

FIG. 2 is a perspective view of the foldable support of the disc drive in FIG. 1;

FIG. 3 is a another perspective view of the disc drive in FIG. 1;

FIG. 4 is a perspective view of the disc drive with the foldable support folded;

FIG. 5 is another perspective view of the disc drive with the foldable support folded;

FIG. 6 is a perspective view of the disc drive diagonally placed by the foldable support;

FIG. 7 is another perspective view of the disc drive diagonally placed by the foldable support;

FIG. 8 is another perspective view of the disc drive diagonally placed by the foldable support;

FIG. 9 is another perspective view of the disc drive diagonally placed by the foldable support;

FIG. 10 is another perspective view of the disc drive diagonally placed by the foldable support; and

FIG. 11 is another perspective view of the disc drive diagonally placed by the foldable support.

### DETAILED DESCRIPTION OF THE INVENTION

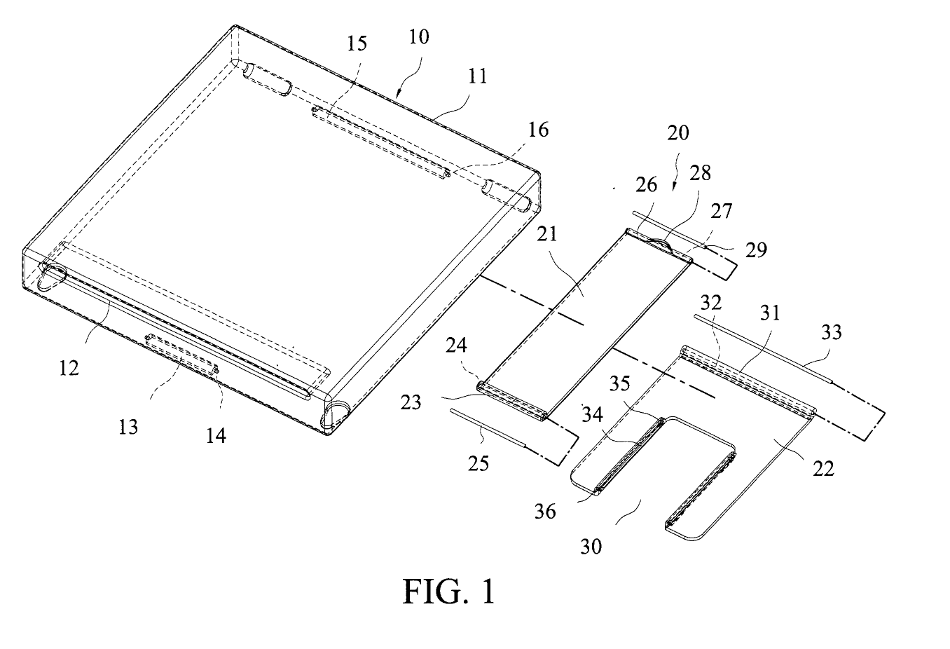

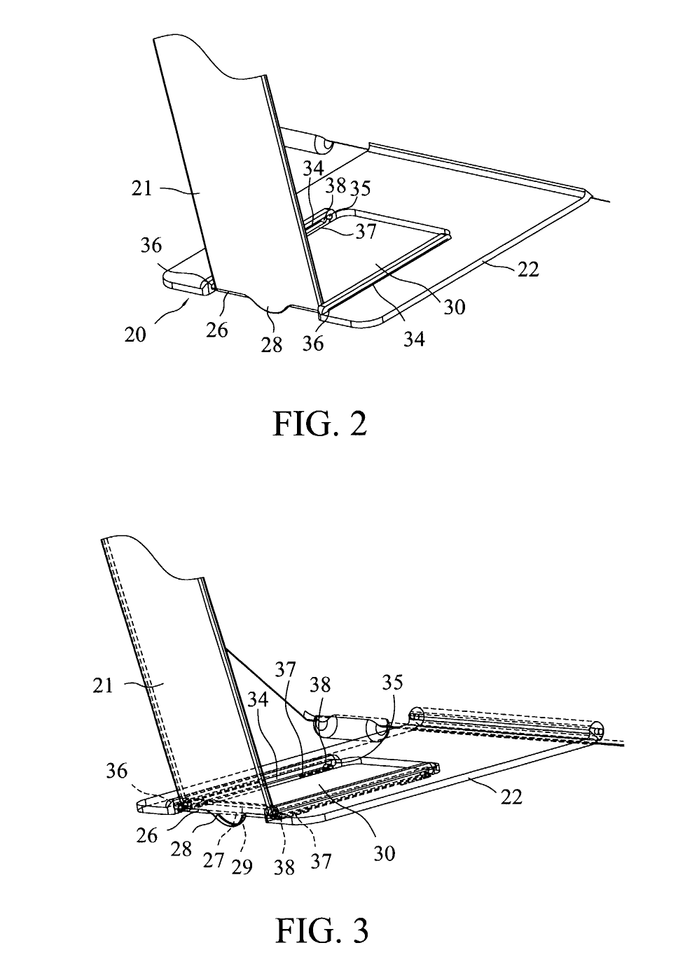

Referring to FIGS. 1, 2 and 3, the present invention provides a disc drive 10 with a foldable support 20 mounted thereon. The disc drive 10 has a main body 11 with an opening 12 on the front surface for accepting discs. An optical reading module is disposed inside the disc drive 10.

In FIGS. 1, 2 and 3, A foldable support 20 is arranged at the bottom of the main body 11 of the disc drive 10. Under the main body 11 near the front surface are a first groove 13. There are two first holes 14 at both ends of the first groove 13. Under the main body 11 opposite the front surface is a second groove 15. There are two second holes 16 at both ends of the second groove 15.

The foldable support 20 includes a first strut 21 and a second strut 22. The first strut 21 may be, but is not limited to, a rectangular plate and has a first pivot portion 23 with a hole 24 there through. The first pivot portion 23 fits into the first groove 13 of the main body 11. The first strut 21 is linked to main body 11 near the front surface of the disc drive 10 by a first shaft 25 passing through the hole 24 of the first pivot portion 23 and engaged to the two first holes 14 so that the first strut 21 can rotate relative to the main body 11.

The first strut 21 has a sliding portion 26 opposite the first pivot portion 23. The sliding portion 26 has a hole 27 and a flange 28 to easily pull the first strut 21. A sliding shaft 29 is disposed in and protrudes from the hole 27 so that the first strut 21 can slide along the second strut 22.

The second strut 22 may be, but is not limited to, a U-shaped plate with a space 30 to hold the first strut 21. The second strut 22 has a second pivot portion 31 at one end with a hole 32 there through. The second pivot portion 31 fits into the second groove 15 of the main body 11. The second strut 22 is linked to main body 11 opposite the front surface of the disc drive 10 by a second shaft 33 passing through the hole 32 of the second pivot portion 31 and engaged to the two second holes 16 so that the second strut 22 can rotate relative to the main body 11.

There are two sliding grooves 34 at the opposite edges of the space 30. At the ends of each sliding groove 34 are a first position 35 and a second position 36. A spring arm 37 with a protrusion 38 thereon is situated at the first position 35 and the second position 36.

The sliding shaft 29 is disposed through the hole 27 and moveably bolted to the sliding grooves 34. When the sliding shaft 29 passes through the protrusion 38 of the spring arm 37, the spring arm 37 returns to its original position and the protrusion 38 fixes the sliding shaft 29 so that the first strut 21 is fixed at the first position 35 or the second position 36, thus forming the mechanism of the foldable support 20.

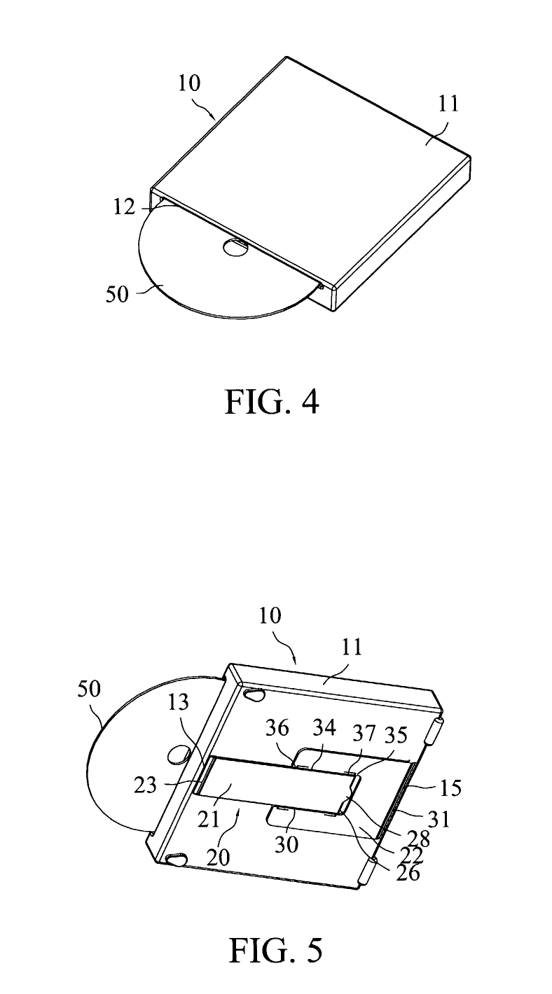

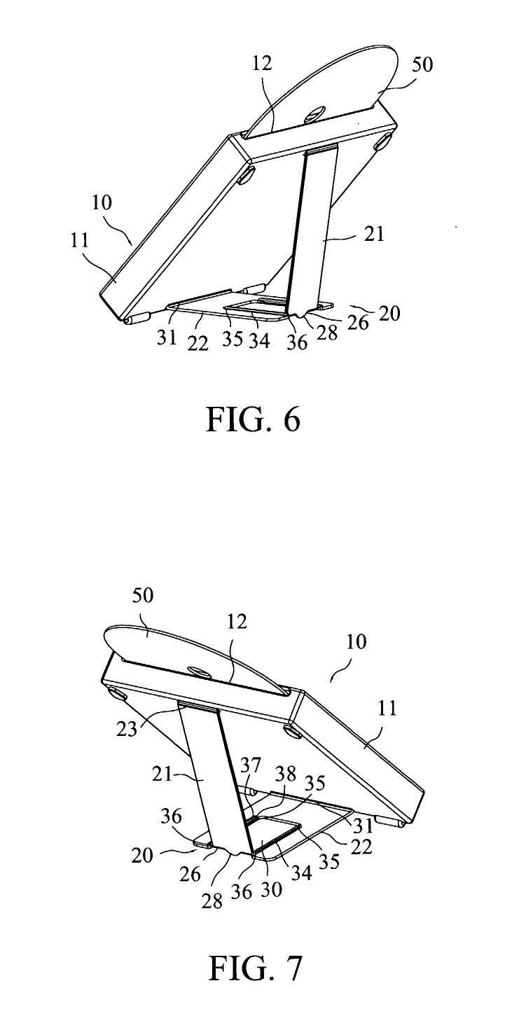

Referring to FIGS. 4 and 5, when the foldable support 20 is folded, the sliding shaft 29 of the first strut 21 is moved to the first position 35 of the sliding groove 34 so that the foldable support 20 is pulled together under the main body 11 of the disc drive 10. At the same time, the disc drive 10 can be deployed horizontally, and the disc 50 can be inserted into the disc drive 10 in a horizontal orientation.

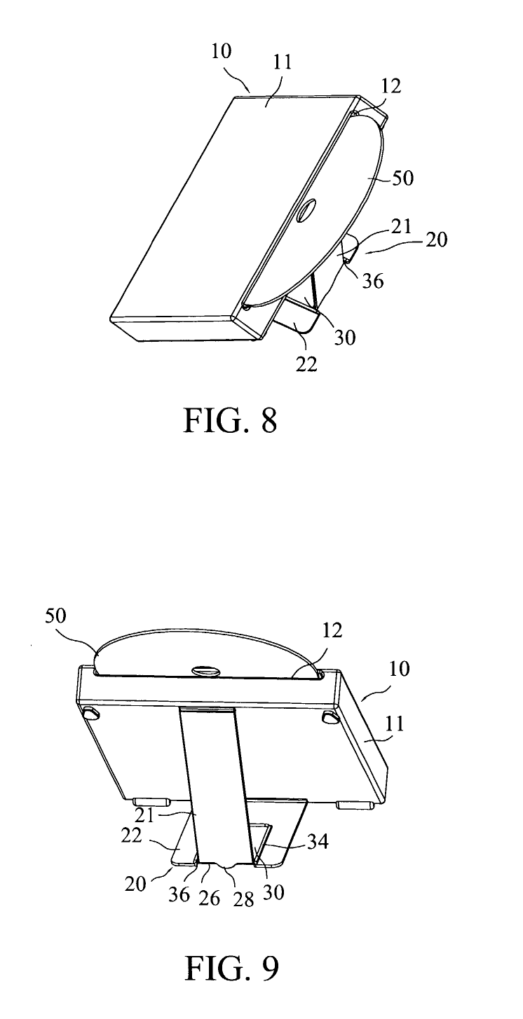

Referring to FIGS. 7, 8, and 9, when the foldable support 20 is extended, the sliding shaft 29 of the first strut 21 is moved to the second position 36 of the sliding groove 34 so that the foldable support 20 is established under the main body 11 of the disc drive 10. At the same time, the disc drive 10 can be deployed diagonally, and the disc 50 can be inserted into the disc drive 10 diagonally.

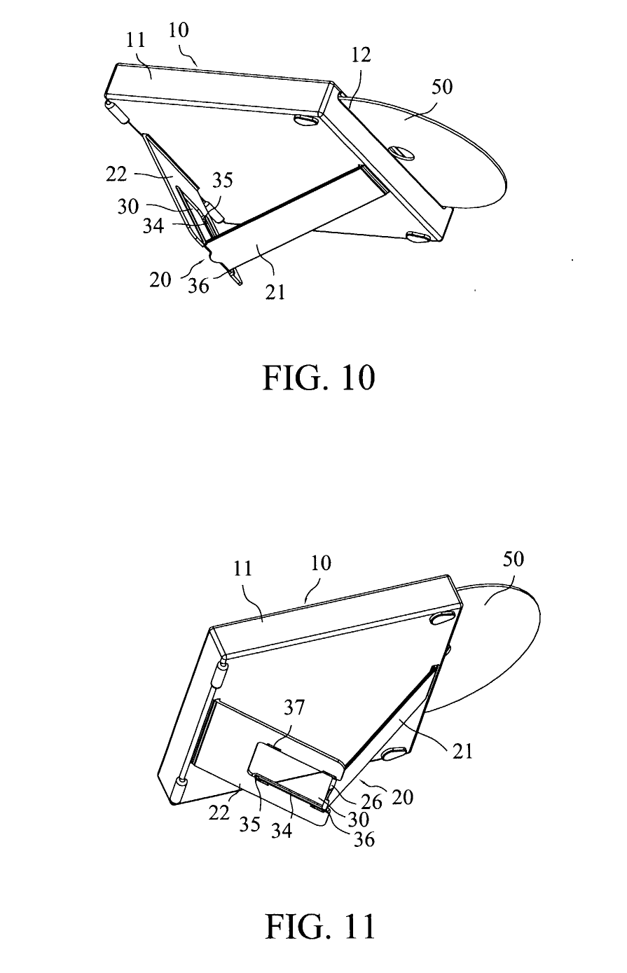

Referring to FIGS. 10 and 11, when the foldable support 20 is extended, the opening 12 of the disc drive 10 can selectively face sideward. At the same time, the disc 50 can be inserted into the disc drive 10 in other orientations.

The present invention provides a disc drive 10 with a foldable support 20, by which the disc drive 10 can be deployed horizontally or diagonally. Thus, it is convenient for users to change the position and direction of the disc drive 10 when using the disc drive 10 with the foldable support 20 of the present invention.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A disc drive with a foldable support, comprising:
a main body, having a front surface; and
a foldable support, including a first strut and a second strut, wherein one end portion of the first strut and the second strut are separately pivoted to the main body, and the other end portion of the first strut is moveably mounted to the second strut so that the main body can be supported and deployed diagonally by the first strut and the second strut.

2. The disc drive with a foldable support as claimed in claim 1, wherein the main body has an opening on the front surface, accepting discs.

3. The disc drive with a foldable support as claimed in claim 1, wherein the main body has a first groove with two first holes under the main body near the front surface, the first strut has a first pivot portion with a first shaft disposed therein and engaged to the first holes so that the first strut rotates relative to the main body.

4. The disc drive with a foldable support as claimed in claim 1, wherein the main body has a second groove with two second holes under the main body opposite the front surface, the second strut has a second pivot portion with a second shaft disposed therein and engaged to the second holes so that the second strut rotates relative to the main body.

5. The disc drive with a foldable support as claimed in claim 1, wherein the first strut has a sliding portion with a sliding shaft at the end opposite the first pivot portion, the second strut has a space with two sliding grooves, the grooves have a first position and a second position with spring arms and protrusions thereon, and the sliding shaft is movably mounted in the sliding grooves and selectively fixed at the first position or second position.

6. The disc drive with a foldable support as claimed in claim 5, wherein the sliding portion has a flange and a through hole, and the sliding shaft is disposed in the hole of the sliding portion.
